(19) United States
(12) Patent Application Publication
(10) Pub. No.: US 2017/0351592 A1
(43) Pub. Date: Dec. 7, 2017

(54) UNIVERSAL SERIAL BUS DEVICE AND A METHOD THEREOF

(71) Applicant: Tzu Ping CHU, Kaohsiung (TW)

(72) Inventor: Tzu Ping CHU, Kaohsiung (TW)

(73) Assignee: Tzu Ping CHU, Kaohsiung (TW)

(21) Appl. No.: 15/172,231

(22) Filed: Jun. 3, 2016

(51) Int. Cl. G06F 11/30; G06F 11/32; G06F 13/42

(52) U.S. Cl. CPC G06F 11/3027; G06F 13/4282; G06F 11/3051; G06F 11/326

(57) ABSTRACT

The present disclosure relates to a universal serial bus device and a method thereof. The universal serial bus device comprises a set of standard metal contacts, at least two functional metal contacts, a processing unit and a substrate. The set of standard metal contacts is electrically connected to a terminal device for planning operations of the universal serial bus device when two functional metal contacts are electrically conducted to each other; the universal serial bus device comprises an extra storage unit in which some engineering functions to delete, backup or restore data can be planned.

### BACKGROUND OF THE INVENTION

### 1) Field of the Invention

The present disclosure relates to a universal serial bus device and a method thereof, particularly a universal serial bus device which limits hardware engineering modes, deletes/backups/restores data in storage spaces automatically, and is manually activated by an operator for preventing the universal serial bus device from tampering of viruses and faults in routine operations.

### 2) Description of the Prior Art

The popularity of the Plug-and-Play (PnP) function makes the Universal Serial Bus (USB) available to personal computers and communications products such as mobile devices and extended to more applications in photographic equipment, digital TVs (set top boxes), game consoles and other appliances.

However, a variety of malicious codes or viruses have infected more appliances via USB storage devices indirectly and aggravated risks of different terminal devices.

In general, malicious codes or viruses invading a storage device's sectors aggravate infection of the storage device and even other undefended appliances when the malicious codes are executed by the terminal device system automatically. Moreover, a pure functional device could become an offensive device with a USB controller tampered via a USB port. Thus, the security risks hidden in USB devices popular with the public may beyond imagination of outsiders because a USB device can be transformed to a malicious device by a hacker tampering with a programmable control chip.

For example, a hacker can enter (install) instructions (malicious codes) into a terminal device by a device simulated to a keyboard or threaten network flows of a terminal device by a device disguised as a network interface card. It is impossible to prevent these risks shown in above examples currently.

The patents related to portable device are presented as follows:

Patent No. TW 1299873 discloses a portable electronic data storage device which comprises: an Autorun LUN (Logic Unit Number) storage sector configured as “read-only” as well as “undeleted” and equipped with a default feature list and an application program, which can be executed automatically to retrieve a unique feature list in a computer that has been electrically connected to the portable electronic data storage device; a Secure LUN storage sector configured to store digital data, which can be accessed when the unique feature list is included in the default feature list.

Patent No. TW 1426389 discloses a storage device which comprises a smart card device and a memory device and links a controller: the storage device is used as a conventional smart card device for saving a great quantity of data in different partitions. One of the partitions could be a “read-only” partition from which data is read only in general. However, data saved in the “read-only” partition may be updated or supplemented sometimes via a host which sends an appropriate instruction with an identifier for valid authorization status to the storage device. Then, the property of the “read-only” partition is changed to “read/write” from “read-only” by the controller and data is written into the partition. Finally, the property of the partition is returned to “read-only” with the “write” operation completed.

Patent No. TW 2010040785 discloses a storage device preventing itself from writing of flash drive viruses, a method of preventing a storage device from writing of flash drive viruses, and a method of preventing a storage device from writing of flash drive viruses by a manufacturer. The storage device is equipped with a main program in read-only memory space which is used to identify flash drive viruses and executed via OS installed in an electronic appliance electrically connected to the storage device. When the storage device is accessed by the electronic appliance, the main program checks the storage device's files related to flash drive viruses and restrains files identified as flash drive viruses. As such, the storage device which has been connected to an electronic appliance infected by flash drive viruses prevents itself from infection.

TW 1414958 discloses a read-only mode to protect removable storage media. The read-only mode is to create a table in which filenames for files inhibited to be written in removable storage media are saved. When data is changed between removable storage media and a storage device possibly infected by viruses, a suspected file which probably infects the removable storage media will not be written in the storage media effectively but other files are normally written. As such, the removable storage media prevents risk of infection and allows data demanded by a user to be written without inconvenience of not using removable storage media for fewer infection risks.

However, the patents, which prevent storage spaces from infection mostly but fail to improve or enhance controllers, are classified into techniques passively defending data but not safe enough.

To solve above issues, a universal serial bus device and a method thereof are provided in the present disclosure.

### SUMMARY OF THE INVENTION

In virtue of above problems, a universal serial bus device and a method thereof provided in the present disclosure rely on functional metal contacts to switch operation modes and a processing unit for signal and operation mode controls to support switching of operation modes in addition to standard metal contacts electrically connected to each other.

A universal serial bus device and a method thereof provided in the present disclosure further prevent an engineering planning function from execution in a normal mode and running of a controller from malicious tampering.

A universal serial bus device and a method thereof provided in the present disclosure further rely on functional metal contacts to differentiate operation modes for fewer faulty operations.

A universal serial bus device and a method thereof provided in the present disclosure further enable a virtual planning compact disc of tool planning for fewer preparations of tools.

A universal serial bus device and a method thereof provided in the present disclosure further reduce costs of maintaining storage devices by deleting data at the hardware level.

A universal serial bus device and a method thereof provided in the present disclosure further rely on functional metal contacts to enable data backup at the hardware level for high compatibility of backup data.

A universal serial bus device and a method thereof provided in the present disclosure further rely on functional metal contacts to enable data restoration at the hardware level for high compatibility of restored data.

A universal serial bus device and a method thereof provided in the present disclosure further display and verify status of a device quickly by a light-emitting unit.

To this end, a universal serial bus device is embodied with technical measures as follows. A universal serial bus device in the present disclosure comprises a set of standard metal contacts, at least two functional metal contacts and a processing unit, all of which are carried by a substrate and electrically connected to one another, and features: the processing unit, which is in a storage device's normal mode and not equipped with an engineering planning function, communicates with a terminal device by signals when the set of standard contacts are electrically connected to a socket in the terminal device; the processing unit, which is in a second mode and equipped with an engineering planning function, communicates with a terminal device by signals when the functional metal contacts are electrically conduced to each other and the set of standard contacts are electrically connected to the socket in the terminal device.

Moreover, a universal serial bus device further depends on following technical measures to realize purposes and techniques.

The universal serial bus device further comprises a storage unit which is carried by and electrically connected to the substrate.

The universal serial bus device further comprises a light-emitting unit which is carried by and electrically connected to the substrate.

In the universal serial bus device, the second mode for planning is to delete, backup, or restore data in the storage unit.

A method to execute a universal serial bus device comprises steps as follows: step 1: two functional metal contacts of a universal serial bus device are electrically conducted to each other; step 2: a set of standard contacts of the universal serial bus device is electrically connected to a socket in a terminal device; step 3: electronic components in the universal serial bus storage device are electrically conducted by power from the socket; step 4: the universal serial bus device communicates with the terminal device by signals emitted from a processing unit in the universal serial bus device which has an engineering planning function.

Moreover, a method to execute a universal serial bus device further depends on following technical measures to realize purposes and techniques.

In the method to execute a universal serial bus device, a virtual planning compact disc of a storage unit in the universal serial bus device which is enabled by the processing unit works as a compact disc in a physical CD-ROM driver and communicates with the terminal device by signals after step 4.

In the method to execute a universal serial bus device, data in a storage unit of the universal serial bus device is deleted and factory defaults are restored after step 4.

In the method to execute a universal serial bus device, a first storage space in a storage unit of the universal serial bus device is reproduced to a second storage space in the storage unit after step 4.

In the method to execute a universal serial bus device, a second storage space in a storage unit of the universal serial bus device is reproduced to a first storage space in the storage unit.

In the method to execute a universal serial bus device, a light-emitting unit in the universal serial bus device signals warning light.

In the method to execute a universal serial bus device, the light-emitting unit signals warning light with another color.

In contrast to conventional techniques, a universal serial bus device and a method thereof have advantages as follows: (1) the engineering mode avoiding a device from malicious tampering; (2) data manipulation at the hardware level for fewer issues related to software compatibility; (3) the function to delete data by hardware and fast recovery of factory defaults; (4) the functions to backup and restore data for simplicity of maintaining personal data.

### BRIEF DESCRIPTIONS OF THE DRAWINGS

FIG. 1 is the first schematic view for a universal serial bus device and a method thereof in a preferred embodiment;

FIG. 2 is the second schematic view for a universal serial bus device and a method thereof in a preferred embodiment;

FIG. 3 is the third schematic view for a universal serial bus device and a method thereof in a preferred embodiment;

FIG. 4 is the fourth schematic view for a universal serial bus device and a method thereof in a preferred embodiment;

FIG. 5 is the fifth schematic view for a universal serial bus device and a method thereof in a preferred embodiment;

FIG. 6 is the sixth schematic view for a universal serial bus device and a method thereof in a preferred embodiment;

FIG. 7 is the first flow diagram for a universal serial bus device and a method thereof in a preferred embodiment;

FIG. 8 is the second flow diagram for a universal serial bus device and a method thereof in a preferred embodiment;

FIG. 9 is the third flow diagram for a universal serial bus device and a method thereof in a preferred embodiment.

### DETAILED DESCRIPTIONS OF THE PREFERRED EMBODIMENTS

A universal serial bus device and a method thereof will be further explained in preferred embodiments for clear understanding of purposes, characteristics and effects.

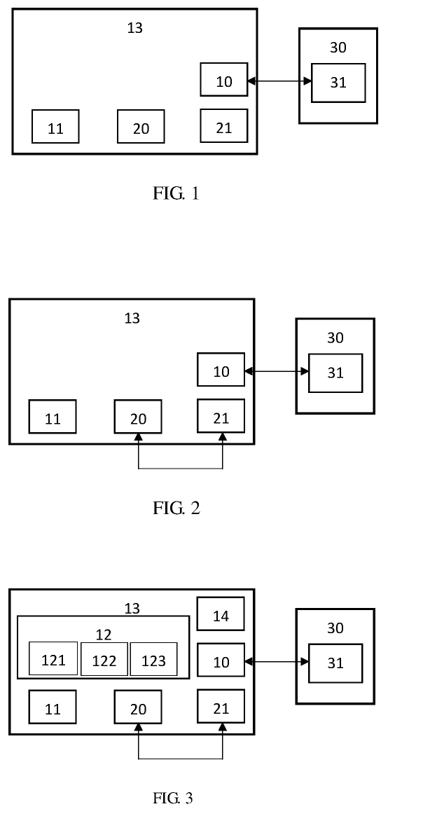

FIG. 1 to FIG. 9 illustrate a universal serial bus device and a method thereof in preferred embodiments. Referring to FIG. 1, which illustrates a universal serial bus device comprising a set of standard metal contacts (10), at least two functional metal contacts (20, 21) and a processing unit (11), all of which are carried on a substrate (13) and electrically connected to one another.

Specifically, the set of standard metal contacts (10) are metal pins of a Universal Serial Bus (USB), for example, four metal pins for Type A before USB 3.0 or nine metal pins for Type A after USB 3.0; the functional metal contacts (20, 21) are metal pins for definitions of functions by which default operations of the processing unit (11) are activated for assisting/enhancing existing functions of a conventional universal serial bus device; the processing unit (11) is a microprocessor (μP) in conformity with specifications of a universal serial bus and consists of electronic components for controls of mater/slave devices, offering of equipment categories and data transmission; the substrate (13) is a high-density double-sided conductive multilayer printed circuit board with circuits (not shown in figures) designed inside and taken to be an interface of electric transmission through which the set of standard metal contacts (10) and the functional metal contacts (20, 21) are electrically connected to the processing unit (11).

Preferably, a universal serial bus device in the present disclosure comprises a storage unit (12) and a light-emitting unit (14), both of which are carried by the substrate (13) and electrically connected to each other.

The storage unit (12) can be various types of memories such as FLASH memory, Static-Random-Access-Memory (SRAM), Application-Specific-Integrated-Circuit (ASIC), Synchronous-Dynamic-Random-Access-Memory (SDRAM); the light-emitting unit (14) consists of Light-Emitting Diodes (LED) which are electroluminescent semiconductor components and triad/pentad-based compound light sources with characteristics of light emission and low power consumption.

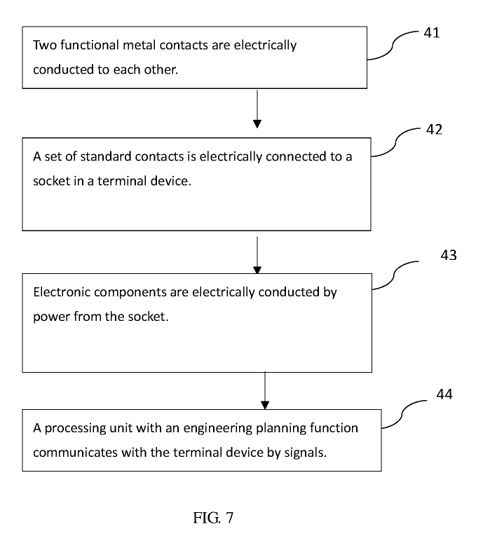

Referring to FIGS. 2 and 7, which illustrate a method of a universal serial bus device executed in the first embodiment according to steps as follows: two functional metal contacts (20, 21) of a universal serial bus device are electrically conducted to each other (step 1: 41); a set of standard contacts (10) of the universal serial bus device is electrically connected to a socket (31) in a terminal device (30) (step 2: 42); electronic components in the universal serial bus storage device are electrically conducted by power from the socket (31) (step 3: 43); the universal serial bus device communicates with the terminal device by signals emitted from a processing unit in the universal serial bus device which has an engineering planning function (step 4: 44).

Referring to FIG. 2 and step 1 (41) for the first embodiment in detail that two functional metal contacts (20, 21) are electrically conducted to each other through an external component or simple drawing with a pencil lead before the universal serial bus device is electrically connected to the terminal device (30). Referring to step 2 (42), which illustrates a set of standard contacts (10) in the universal serial bus device is electrically connected to a socket (31) of a terminal device (30). Next, the socket (31) in step 3 (43) is electrified and the standard metal contacts (10), the processing unit (11), the functional metal contacts (20, 21) and the substrate (13) in the USB storage device are conducted electrically for initializing electronic components in the USB storage device. Referring to step (4), which illustrates the processing unit (11) with an engineering planning function communicates with the terminal device (30) by signals through the set of standard contacts (10).

Specifically, step 1 (41) explains the two functional metal contacts (20, 21) in FIG. 2 are electrically conducted to each other, step 2 (42) presents a procedure of electricity received by the universal serial bus device and signal-based communications, step 3 (43) illustrates electronic components in the universal serial bus device are electrified for operations, and step 4 (44) demonstrates the universal serial bus device has an engineering planning function or has not an engineering planning function in the case of no condition in step 1 (41) (as shown in FIG. 1).

The engineering planning function is a compatible USB communications mode between the processing unit (11) and the terminal device (30) for device category, keyboard's default input signal, network signal guidance, etc.

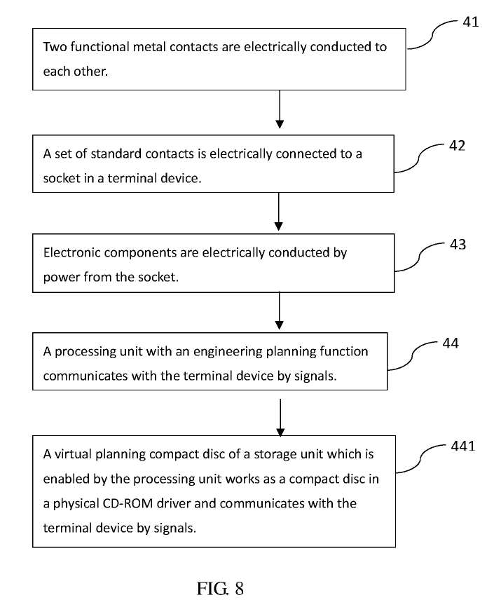

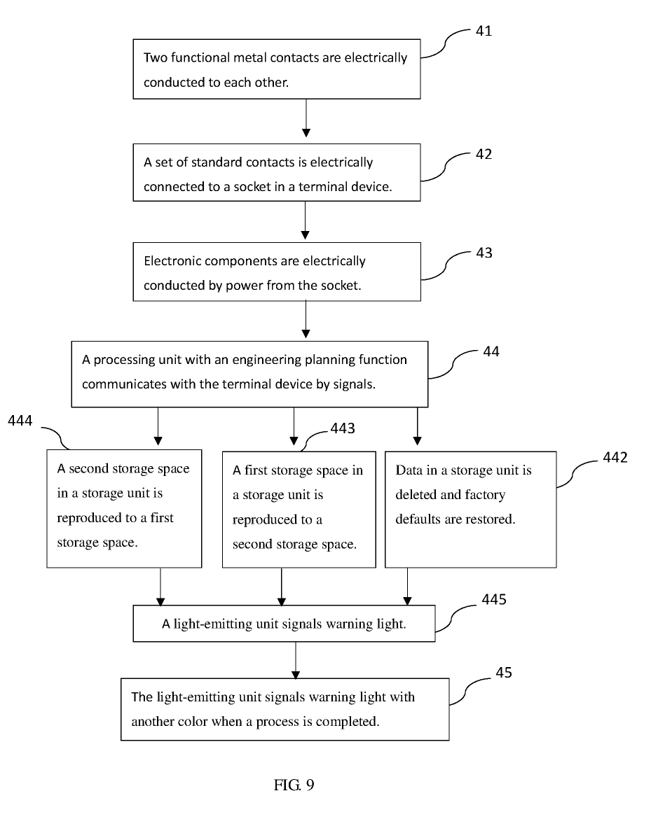

Referring to FIGS. 3 and 8 that illustrate a universal serial bus device and a method thereof in the second embodiment in which the symbols identical to those of the first embodiment in FIGS. 1, 2 and 7 are not explained hereinafter. The differences in the second embodiment are one storage unit (12) installed in the universal serial bus device and step 4-1 (441) for addition of a virtual planning compact disc after step 4 (44).

Specifically, a virtual planning compact disc (121) of a storage unit (12) in the universal serial bus device which is enabled by the processing unit (11) works as a compact disc in a physical CD-ROM driver and communicates with the terminal device (30) by signals after step 4-1 (441), as shown in FIGS. 3 and 8.

In practice, the virtual planning compact disc (121) is data stored in the storage unit (12) and transmitted to the terminal device (30) by signals as a physical CD-ROM driver. In the embodiment, the virtual planning compact disc (121) implies engineering software, which is used to configure the processing unit (11), reduce tool searches, and enable an engineering planning function for planning of device categories, keyboard's default input signals, and network signal guidance, etc. in the case of neither a first storage space (122) nor a second storage space (123) in FIG. 3 existing and even configure sector sizes in the case of both a first storage space (122) and a second storage space (123) existing.

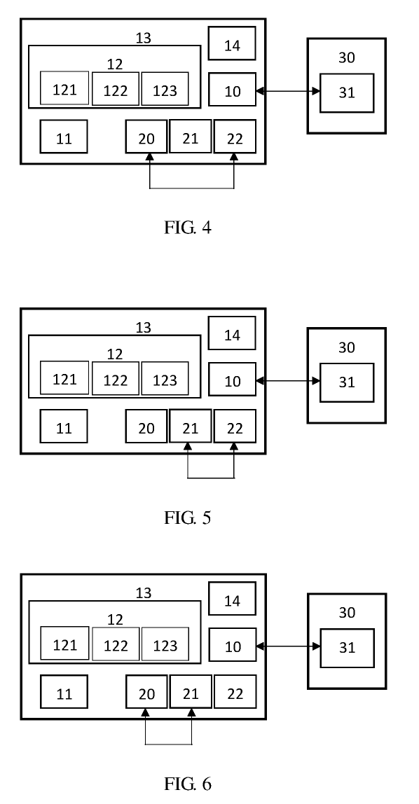

Referring to FIGS. 4, 5, 6 and 9 that illustrates a universal serial bus device and a method thereof in the third embodiment in which the symbols identical to those of the first (second) embodiment in FIGS. 1, 2, 3, 7 and 8 (FIGS. 4, 5, 6 and 9) are not explained hereinafter. The differences in the third embodiment are one storage unit (12) and three functional metal contacts (20, 21, 22), both of which are installed in the universal serial bus device, and extra steps of step 4-2 (442), step 4-3 (443), step 4-4 (444), step 4-5 (445) and step 5 (45) after step 4 (44) to clear, backup or restore data inside the storage unit (12).

In the third embodiment, three procedures for “clear”, “backup” and “restore” are explained hereinafter. As shown in FIGS. 4 and 9 for “clear”, step 4-2 (442) after completion of the first embodiment (in which two functional metal contacts (20, 22) amid three functional metal contacts (20, 21, 22) in step 1 (41) are electrically conducted to each other) is to delete data in a storage unit (12) of the universal serial bus device and restore factory defaults; step 4-5 (445) illustrates a light-emitting unit (14) in the universal serial bus device signals warning light and is followed by step 5 (45) in which the color of warning light is changed by the light-emitting unit (14).

Furthermore, as shown in FIGS. 5 and 9 for “backup”, step 4-3 (443) after completion of the first embodiment (in which two functional metal contacts (21, 22) amid three functional metal contacts (20, 21, 22) in step 1 (41) are electrically conducted to each other) is to reproduce a first storage space (122) of a storage unit (12) in the universal serial bus device to a second storage space (123) of the storage unit (12); step 4-5 (445) illustrates a light-emitting unit (14) in the universal serial bus device signals warning light and is followed by step 5 (45) in which the color of warning light is changed by the light-emitting unit (14).

Finally, as shown in FIGS. 6 and 9 for “restore”, step 4-4 (444) after completion of the first embodiment (in which two functional metal contacts (20, 21) amid three functional metal contacts (20, 21, 22) in step 1 (41) are electrically conducted to each other) is to reproduce a second storage space (123) of a storage unit (12) in the universal serial bus device to a first storage space (122) of the storage unit (12); step 4-5 (445) illustrates a light-emitting unit (14) in the universal serial bus device signals warning light and is followed by step 5 (45) in which the color of warning light is changed by the light-emitting unit (14).

Specifically, the first storage space (122) and the second storage space (123) are sectors for data storage in the storage unit (12) which is taken as an external storage device by the processing unit (11) for communications between the storage unit (12) and the terminal device (30) by signals; the functional metal contacts (20, 21, 22) interact one another and have effect on an operation mode through a combination of two functional metal contacts (20, 22) in FIG. 4, two functional metal contacts (21, 22) in FIG. 5, or two functional metal contacts (20, 21) in FIG. 6; the light-emitting unit (14) presents status of “clear”, “backup” or “restore” data in the storage unit (12) by colors of warning light or flash frequencies to a user.

Accordingly, a universal serial bus device in the present disclosure, which differs from general universal serial bus devices, is referred to as creative work in applications, meets patentability, and is applied for the patent.

It should be reiterated that the above descriptions present preferred embodiments, and any equivalent change in specifications, claims, or drawings still belongs to the technical field within the present disclosure with reference to claims hereinafter.

What is claimed is:

1. A universal serial bus device, comprising a set of standard metal contacts (10), at least two functional metal contacts (20, 21) and a processing unit (11), all of which are carried by a substrate (13) and electrically connected to one another, and featuring: the processing unit (11), which is in a storage device's normal mode and not equipped with an engineering planning function, communicates with a terminal device (30) by signals when the set of standard contacts (10) are electrically connected to a socket (31) in the terminal device (30); the processing unit (11), which is in a second mode and equipped with an engineering planning function, communicates with a terminal device (30) by signals when the functional metal contacts (20, 21) are electrically conduced to each other and the set of standard contacts (10) are electrically connected to the socket (31) in the terminal device (30).

2. A universal serial bus device as claimed in claim 1 further comprising a storage unit (12) which is carried by and electrically connected to the substrate (13).

3. A universal serial bus device as claimed in claim 1 further comprising a light-emitting unit (14) which is carried by and electrically connected to the substrate (13).

4. A universal serial bus device as claimed in claim 2 wherein the second mode for planning is to delete, backup, or restore data in the storage unit.

5. A method to execute a universal serial bus device comprising steps: step 1: two functional metal contacts of a universal serial bus device are electrically conducted to each other (41); step 2: a set of standard contacts of the universal serial bus device is electrically connected to a socket in a terminal device (42); step 3: electronic components in the universal serial bus storage device are electrically conducted by power from the socket (43); step 4: the universal serial bus device communicates with the terminal device by signals emitted from a processing unit in the universal serial bus device which has an engineering planning function (44).

6. A method to execute a universal serial bus device as claimed in claim 5 wherein a virtual planning compact disc of a storage unit in the universal serial bus device which is enabled by the processing unit works as a compact disc in a physical CD-ROM driver and communicates with the terminal device by signals after step 4 (441).

7. A method to execute a universal serial bus device as claimed in claim 5 wherein data in a storage unit of the universal serial bus device is deleted and factory defaults are restored after step 4 (442).

8. A method to execute a universal serial bus device as claimed in claim 5 wherein a first storage space in a storage unit of the universal serial bus device is reproduced to a second storage space in the storage unit after step 4 (443).

9. A method to execute a universal serial bus device as claimed in claim 5 wherein a second storage space in a storage unit of the universal serial bus device is reproduced to a first storage space in the storage unit (444).

10. A method to execute a universal serial bus device as claimed in claim 7 wherein a light-emitting unit in the universal serial bus device signals warning light (445).

11. A method to execute a universal serial bus device as claimed in claim 8 wherein a light-emitting unit in the universal serial bus device signals warning light (445).

12. A method to execute a universal serial bus device as claimed in claim 9 wherein a light-emitting unit in the universal serial bus device signals warning light (445).

13. A method to execute a universal serial bus device as claimed in claim 10 wherein the light-emitting unit signals warning light with another color after the method is executed completely (45).

14. A method to execute a universal serial bus device as claimed in claim 11 wherein the light-emitting unit signals warning light with another color after the method is executed completely (45).

15. A method to execute a universal serial bus device as claimed in claim 12 wherein the light-emitting unit signals warning light with another color after the method is executed completely (45).
